(19) United States
(12) Patent Application Publication
(10) Pub. No.: US 2017/0285195 A1
(43) Pub. Date: Oct. 5, 2017

(54) INTEGRATING VERTICAL SEISMIC PROFILE DATA FOR MICROSEISMIC ANISOTROPY VELOCITY ANALYSIS

(71) Applicant: HALLIBURTON ENERGY SERVICES, INC., Houston, TX (US)

(72) Inventors: Donghong PEI, Houston, TX (US); Norman R. WARPINSKI, Cypress, TX (US); Sean Robert MACHOVOE, Houston, TX (US); Pedro William PALACIOS, Katy, TX (US)

(73) Assignee: HALLIBURTON ENERGY SERVICES, INC., Houston, TX (US)

(21) Appl. No.: 15/510,790

(22) PCT Filed: Oct. 1, 2014
(86) PCT No.: PCT/US2014/058556

§ 371 Date: Mar. 13, 2017

(51) Int. Cl. G01V 1/30; G01V 1/42

(52) U.S. Cl. CPC G01V 1/303; G01V 1/42; G01V 2210/161; G01V 2210/6222; G01V 2210/626

(57) ABSTRACT

A system and a method for producing an anisotropic velocity model. Vertical seismic profile (VSP) data is obtained for a geological area. At least two stiffness coefficients in a fourth-rank elasticity stiffness tensor are calculated based on p-wave and s-wave velocities determined using the VSP data. Microseismic profile data for the geological area is obtained and all remaining unknown stiffness coefficients in the fourth-rank elasticity stiffness tensor are calculated using the microseismic profile data.

### FIELD

The disclosure relates generally to microseismic anisotropy velocity analysis and more specifically to microseismic anisotropy velocity analysis with integrated vertical seismic profile data.

### BACKGROUND

Seismic data is used to monitor underground events in subterranean rock formations. In order to investigate these underground events, micro-earthquakes, also known as microseisms, are detected and monitored. Like earthquakes, microseisms emit elastic waves—compressional (“p-waves”) and shear (“s-waves”). Microseisms occur at much higher frequencies than those of earthquakes. Generally, microseisms have a frequency within the acoustic frequency range of 200 Hz to more than 2000 Hz.

Hydraulic fracturing involves pumping fluid into wells at sufficient pressure to fracture surrounding rock. The fractures provide conduits to enhance gas flow. The fluid also transports a propping agent (also known as “proppant”) into the fractures to help keep the fracture open when the fracturing operation ceases.

Water flooding of largely expended oil fields seeks to push oil to other wells where it might be produced. Steam can also be used to increase pressure and/or temperature to further displace the oil. Fractures are often created during water flooding. The fractures can direct the oil in a potentially unknown direction.

Microseismic detection is often utilized in conjunction with hydraulic fracturing or water flooding techniques to map created fractures. A hydraulic fracture induces an increase in the formation stress proportional to the net fracturing pressure as well as an increase in pore pressure due to fracturing fluid leak off. Large tensile stresses are formed ahead of the crack tip, which creates large amounts of shear stress. Both pore pressure and increases in formation stress affect the stability of planes of weakness surrounding the hydraulic fracture and cause them to undergo shear slippage. Examples of planes of weakness can include natural fractures and bedding planes. It is these shear slippages that are analogous to small earthquakes along faults.

Microseisms can be detected with multiple receivers (transducers) deployed on a wireline array in one or more offset well bores. With the receivers deployed in several wells, the microseism locations can be triangulated as is done in earthquake detection.

Generally, the purposes of microseismic monitoring can include, but are not limited to: knowing the fracturing direction; identifying the extent of fracturing; avoiding faults and other hazards; understanding how the rock broke; and planning future well placement and stimulations.

Complications can, however, occur when attempting to map the hydraulic fracture geometry and azimuth based microseisms that must travel through an anisotropic medium before reaching the receivers. A material is said to be anisotropic if the value of a vector measurement of a rock property varies with direction. Anisotropy differs from the rock property called heterogeneity in that anisotropy is the variation in vectorial values with direction at a point while heterogeneity is the variation in scalar or vectorial values between two or more points. There are two main types of anisotropy: transverse isotropy or polar isotropy. In transverse isotropy, isotropy exists in the horizontal or vertical plane. Vertical transverse isotropy (VTI) media have a vertical axis of symmetry. This kind of anisotropy is associated with layering and shale and is found where gravity is the dominant factor. Similarly, horizontal transverse isotropy (HTI) is isotropy with a horizontal axis of symmetry.

An additional technology is Vertical Seismic Profile (VSP). VSP is a technique of seismic measurements to obtain high resolution reservoir information and details. VSP employs an energy source or detector within a borehole to obtain a seismic profile.

There is a need for a system and a method for microseismic anisotropy velocity analysis that produces an accurate solution for anisotropic media.

### BRIEF DESCRIPTION OF THE DRAWINGS

These and other features, aspects, and advantages of the present disclosure will become better understood with reference to the following description and appended claims, and accompanying drawings where:

FIG. 1 is a schematic of a system for collecting microseismic data according to one embodiment;

FIG. 2 is a graph of the data generated by one embodiment;

FIGS. 3a-g are exemplary schematic illustrations for obtaining vertical seismic profiles;

FIG. 4 is a schematic of a system for obtaining vertical seismic profile data according to one embodiment;

FIG. 5 is a schematic block diagram of an exemplary workflow; and

FIG. 6 FIG. 6 is a block diagram of a hardware computer.

It should be understood that the various embodiments are not limited to the arrangements and instrumentality shown in the drawings.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

All numeric values are herein assumed to be modified by the term “about,” whether or not explicitly indicated. The term “about” generally refers to a range of numbers that one of skill in the art would consider equivalent to the recited value (i.e., having the same function or result). In many instances, the term “about” may include numbers that are rounded to the nearest significant figure. In some examples, the steps, systems, transmitting systems, computers, herein can employ or be carried out with a processor optionally coupled directly or indirectly to memory elements through a system bus, as well as program code for executing and carrying out processes described herein. A “processor” as used herein is an electronic circuit that can make determinations based upon inputs. A processor can include a microprocessor, a microcontroller, and a central processing unit, among others. While a single processor can be used, the present disclosure can be implemented over a plurality of processors.

Various embodiments are disclosed for a system and a method for microseismic anisotropy velocity analysis that produces an accurate solution for anisotropic media, particularly for VTI media. Various embodiments disclose microseismic anisotropy velocity analysis with integrated vertical seismic profile data.

Anisotropic media is characterized by a material stiffness matrix. A total of five unknown stiffness coefficients (c₁₁, c₃₃, c₅₅, c₆₆, c₁₃—derived further below) are required to determine the seismic phase velocities of seismic waves traveling through a VTI medium. Microseismic detection is employed to solve for and determine the unknown coefficients. However, VSP analysis is employed to solve for two of the five stiffness coefficients, namely the c₃₃, c₅₅ coefficients. The integration of these VSP results accordingly reduces the number of unknowns from five to three, greatly improving the reliability of analysis. Accordingly the properties of the rock in the formation can be more accurately determined.

The involved equations are derived in the following. The stresses and strains of a continuous elastic material exhibiting linear elasticity can be related by Hooke's law, given by Equation 1.

σ=Cε (1),

where σ is the stress tensor of the material, ε is the strain tensor of the material, and C is a fourth-order tensor. A fourth-order tensor is a linear map between second-order tensors. C can be referred to as the stiffness tensor or the elasticity tensor. Using Voigt notation, Equation 1 can be written as shown in Equation 2.

$$[ \begin{matrix}{σ}_{1} \\ {σ}_{2} \\ {σ}_{3} \\ {σ}_{4} \\ {σ}_{5} \\ {σ}_{6}\end{matrix} ] = [ \begin{matrix}{C}_{11} & {C}_{12} & {C}_{13} & {C}_{14} & {C}_{15} & {C}_{16} \\ {C}_{12} & {C}_{22} & {C}_{23} & {C}_{24} & {C}_{25} & {C}_{26} \\ {C}_{13} & {C}_{23} & {C}_{23} & {C}_{34} & {C}_{35} & {C}_{35} \\ {C}_{14} & {C}_{24} & {C}_{34} & {C}_{44} & {C}_{45} & {C}_{46} \\ {C}_{15} & {C}_{25} & {C}_{35} & {C}_{45} & {C}_{55} & {C}_{56} \\ {C}_{16} & {C}_{26} & {C}_{36} & {C}_{46} & {C}_{56} & {C}_{66}\end{matrix} ] [ \begin{matrix}{ɛ}_{1} \\ {ɛ}_{2} \\ {ɛ}_{3} \\ {ɛ}_{4} \\ {ɛ}_{5} \\ {ɛ}_{6}\end{matrix} ] \qquad ( 2 )$$

For VTI media, the stiffness tensor is further simplified to equation 3. (of course, the equation number should be changed accordingly in the whole document.)

$${C}^{VTI} = ( \begin{matrix}{c}_{11} & {c}_{11} - 2 {c}_{66} & {c}_{13} & 0 & 0 & 0 \\ {c}_{11} - 2 {c}_{66} & {c}_{11} & {c}_{13} & 0 & 0 & 0 \\ {c}_{13} & {c}_{13} & {c}_{33} & 0 & 0 & 0 \\ 0 & 0 & 0 & {c}_{55} & 0 & 0 \\ 0 & 0 & 0 & 0 & {c}_{55} & 0 \\ 0 & 0 & 0 & 0 & 0 & {c}_{66}\end{matrix} ) \qquad ( 3 )$$

where stiffness coefficients Cᵢⱼ are responsible for material properties, in this case the rock properties of the formation. As noted above, a total of five unknown stiffness coefficients (c₁₁, c₃₃, c₅₅, c₆₆, c₁₃) are required to determine the seismic phase velocities of seismic waves traveling through a VTI medium.

Sample seismic rays traveling through the media at various angles, preferably at phase angles from zero to 90 degree, can be used to realistically invert Equation 3 for the five unknown stiffness coefficients (c₁₁, c₃₃, c₅₅, c₆₆, c₁₃).

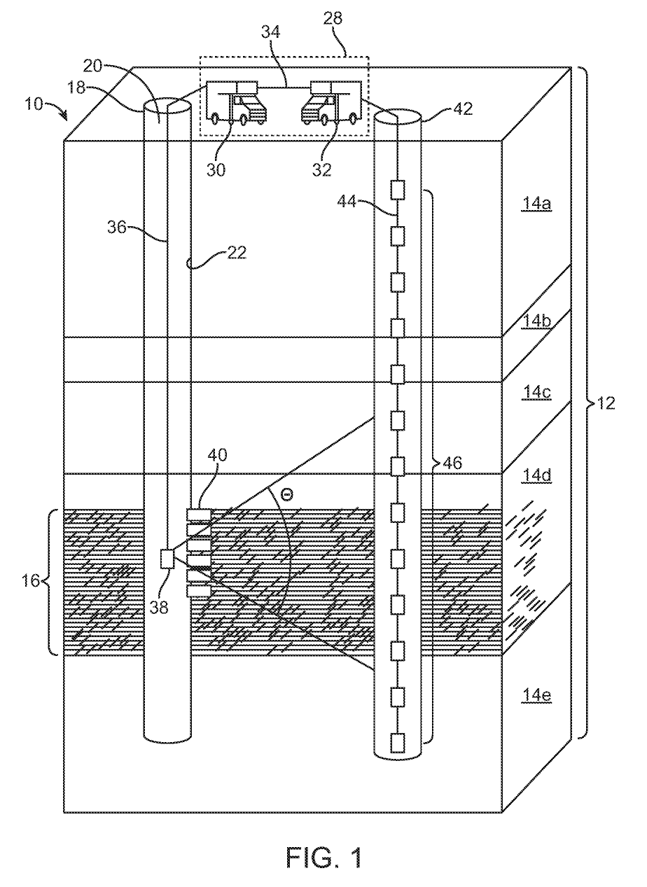

Microseismic detection can be used to measure the sample seismic rays traveling through the media. For example, intentionally created microseisms can be detected with multiple receivers (transducers) deployed on a wireline array in one or more offset well bores. With receivers deployed in several wells, the microseism locations can be triangulated. Triangulation can be accomplished by determining the arrival times of the various p- and s-waves, and using formation velocities to find the best-fit location of the microseisms. As illustrated in FIG. 1, this type of microseismic detection requires at least one offset observation well nearby.

Referring now to FIG. 1, a partial cutaway view 10 is shown with a treatment well 18 that extends downward into strata 12, through one or more geological layers 14 a-14 e. While wells are conventionally vertical, the disclosure is not limited to use with vertical wells. Thus, the terms “vertical” and “horizontal” are used in a general sense in their reference to wells of various orientations.

The preparation of treatment well 18 for hydraulic fracturing typically comprises drilling a bore 20. Bore 20 may be drilled to any desired depth. A casing 22 may be cemented into well 18 to seal the bore 20 from the geological layers 14.

A perforation timing assembly 28 can be used to conduct microseismic fracture mapping using seismic source timing measurements for velocity calibration. In one embodiment, perforation timing assembly 28 comprises a transmitter system 30 and a data analysis system 32 coupled via a transmitting medium 34, such as fiber optic cable, wire cable, radio or other conventional transmission system.

Transmitter system 30 can include a transmitter assembly, including for example a sensor or current probe, an amplifier, a filter, a function generator or trigger detection circuits, an oscilloscope and a transmitter. The analysis system 32 can include a data analysis system, including for example a receiver, an amplifier, a digital converter, an analog signal recorder, a speaker, an analyzer, and a storage memory or device. The transmitter system 30 and analysis system 32 can comprise personal or network computers or any computing device or processor for carrying out any functions, steps or calculations.

In one embodiment, transmitter system 30 is attached to a wireline 36 that is extended into well 18. A seismic source 38 may be coupled to wireline 36. As one skilled in the art will appreciate, seismic source 38 may be any type of apparatus capable of generating a seismic event, for example, a perforating gun, string shot, primacord wrapped around a perforation gun or other tool, or any other triggered seismic source. In one embodiment, seismic source is triggered electrically through wireline 36. For testing purposes, a perforating gun simulator could be coupled to wireline 36 in addition to, or in lieu of, perforating gun, acting as seismic source 38.

In one embodiment, where the perforating gun is a seismic source 38, the perforating gun creates perforations 40 through casing 22. While embodiments of the present disclosure may be practiced in a cased well, it is contemplated that embodiments of the present disclosure may also be practiced in an uncased well.

The perforating gun, acting as seismic source 38, may be raised and lowered within well 18 by adjusting the length of wireline 36. The location of perforations 40 may be at any desired depth within well 20, but are typically at the level of a rock formation 16, which may be within one or more of the geological layers 14a-14 e. Rock formation 16 may consist of oil and/or gas, as well as other fluids and materials that have fluid-like properties.

In one embodiment, data analysis system 32 may extend a wireline 44 into a well 42. One or more receiver units 46 may be coupled to wireline 44. In one embodiment, an array of receiver units 46 are coupled to wireline 44. Receiver units 46 preferably contain tri-axial seismic receivers (transducers) such as geophones or accelerometers, i.e., three orthogonal geophones or accelerometers, although for some applications it will not be necessary that receivers be used for all three directions. The type of receiver unit chosen will depend upon the characteristics of the event to be detected. In one embodiment, the characteristic may be the frequency of the event.

The desired amount of independent information, as well as the degree of accuracy of the information to be obtained from a seismic event will affect the minimum number of receiver units 46 used. In a number of applications, including the hydraulic fracturing technique, important information includes the elevation of the source of the microseismic waves with regard to an individual receiver unit 46, and the distance away from a given receiver unit 46. Time of origination of seismic event is a frequently used metric, as well. At least one receiver unit can be vertically disposed within well 42 on a wireline 44. According to certain embodiments of the present disclosure, multiple receiver units 46 may be spaced apart on wireline 44. The distance between individual receiver units 46 in a multi-unit array is selected to be sufficient to allow a measurable difference in the time of arrival of acoustic waves from a seismic event that originates from well 18.

Well 42 may be laterally spaced from well 18 and may extend downwardly through rock formation 16. While in many instances only a single offset well bore is available near the treatment well, it will be appreciated that multiple wells 42 may exist in proximity to well 18, and that multiple data analysis systems 32 may be used in with multiple wells 42. The distance between well 18 and well 42 is often dependent on the location of existing wells, and the permeability of the local strata. For example, in certain locations, the surrounding strata may require that well 18 and well 42 to be located relatively close together. In other locations, the surrounding strata may enable well 18 and well 42 to be located relatively far apart. It will also be appreciated that well 42 may contain a casing or be uncased.

Still referring to FIG. 1, it can be seen that microseismic detection can provide sample seismic rays travelling through the media from perforating gun 38 toward receiver units 46 at a limited range of angles within angle θ. The number of angles is limit by the microseismic shot-receiver geometry. The narrower range of angles limits the accuracy with which the five unknown stiffness coefficients from Equation 3 can be determined.

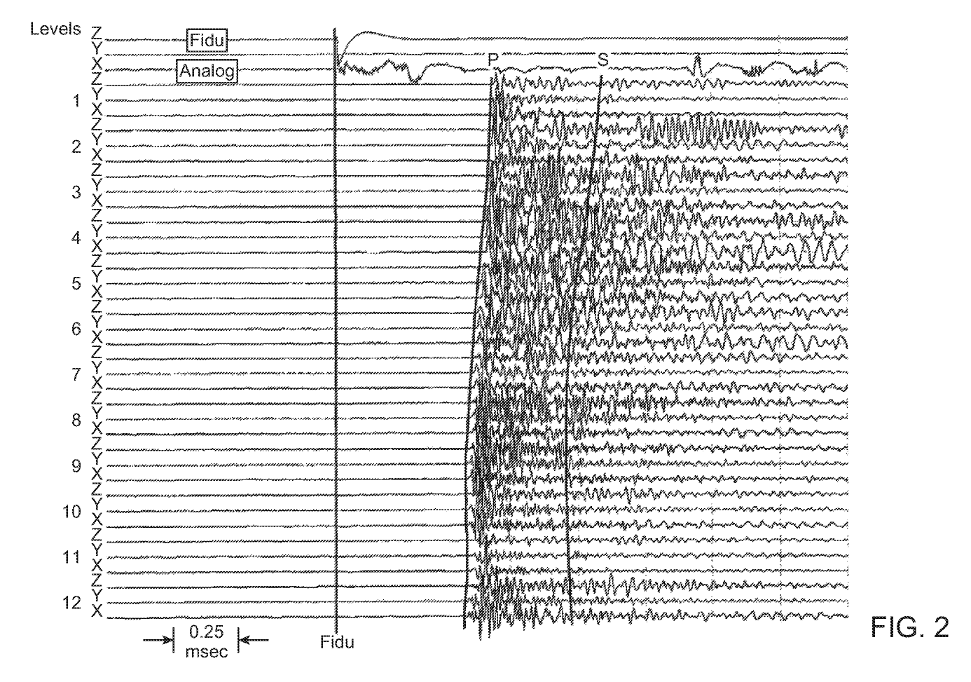

FIG. 2 depicts a data set with the fiduciary perforation timing signal (perforation fidu) and the seismic arrivals of the perforation signals. The top trace shows the perforation fidu. The next trace is not used, but the third trace shows the analog signal from the sensor probe. The remaining traces are the seismic data from the receiver units in groups of three. The arrivals are the compressional wave (p-wave) and the timing difference between the perforation fidu and the arrival can be used to determine the velocity between the perforation location and the receiver unit location. In this data set, twelve receiver units were used.

Again, in order to provide more realistic values for the five unknown stiffness coefficients (c₁₁, c₃₃, c₅₅, c₆₆, c₁₃) in Equation 3, it is desirable to have sample seismic rays traveling through the media at various angles, preferably at phase angles from zero to 90 degree.

As expressed earlier, microseisms emit elastic waves—compressional (“p-waves”) and shear (“s-waves”). Shear waves have been observed to split into two or more fixed polarizations which can propagate in the particular ray direction when entering an anisotropic medium. These split phases propagate with different polarizations and velocities. Therefore, developing an accurate anisotropic velocity model can have a large impact on the location accuracy of microseismic events associated with hydraulic fracture monitoring in or near an anisotropic medium. Accurate locations of these events form the basis for interpretation of hydraulically stimulated regions such as the calculation of the fracture density and SRV (Stimulated Reservoir Volume) value.

A transversely isotropic material is one with physical properties which are symmetric about an axis that is normal to a plane of isotropy. This transverse plane has infinite planes of symmetry and thus, within this plane, the material properties are the same in all directions.

According to various embodiments of the disclosure microseismic data obtain from a microseismic detection system as illustrated in FIG. 1 can be combined with Vertical Seismic Profile (VSP) data.

Many VSP types can be employed. Zero-offset VSPs having sources close to the wellbore directly above receivers can be employed. Offset VSPs having sources some distance from the receivers in the wellbore can be employed. Walkaway VSPs featuring a source that is moved to progressively farther offset and receivers held in a fixed location can be employed. Walk-above VSPs accommodate the recording geometry of a deviated well, having each receiver in a different lateral position and the source directly above the receiver can be employed. Salt-proximity VSPs, Drill-noise VSPs, and Multi-offset VSPs can also be employed. For example, Salt-proximity VSPs are reflection surveys to help define a salt-sediment interface near a wellbore by using a source on top of a salt dome away from the drilling rig. Drill-noise VSPs, also known as seismic-while-drilling (SWD) VSPs, use the noise of the drill bit as the source and receivers laid out along the ground. Multi-offset VSPs involve a source some distance from numerous receivers in the wellbore.

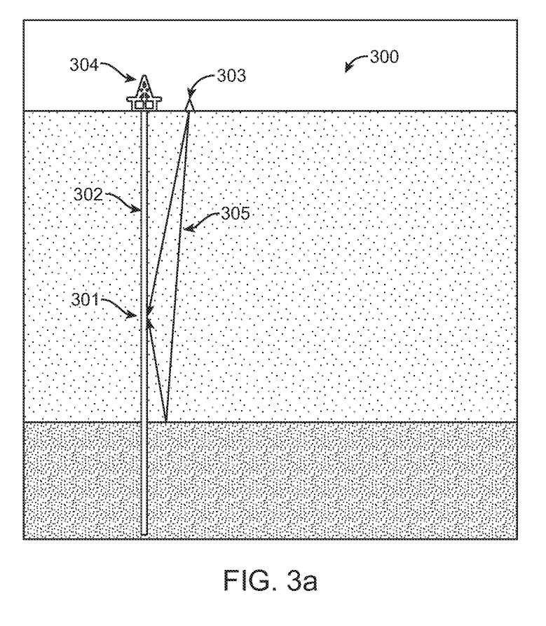

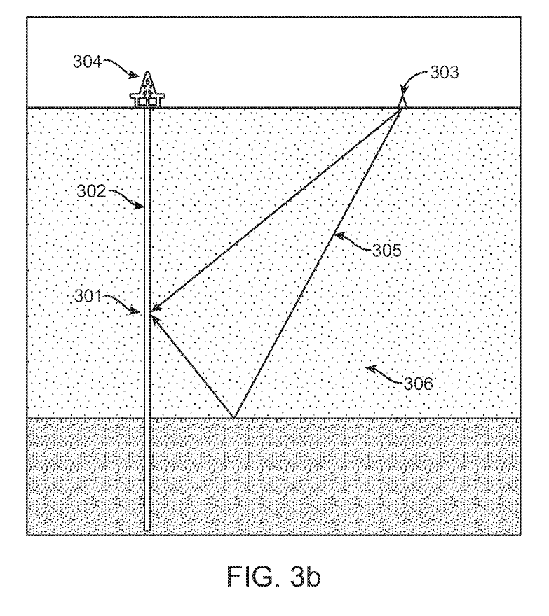

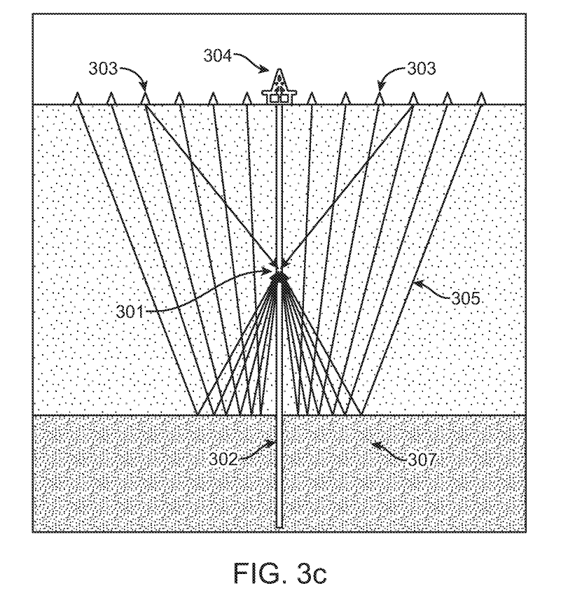

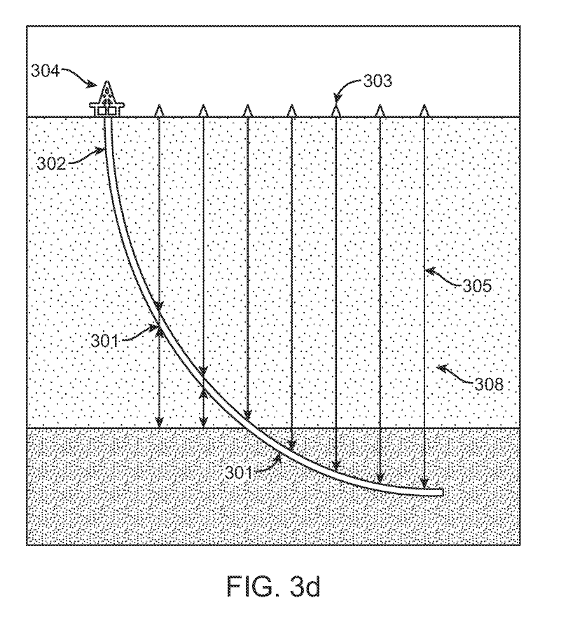

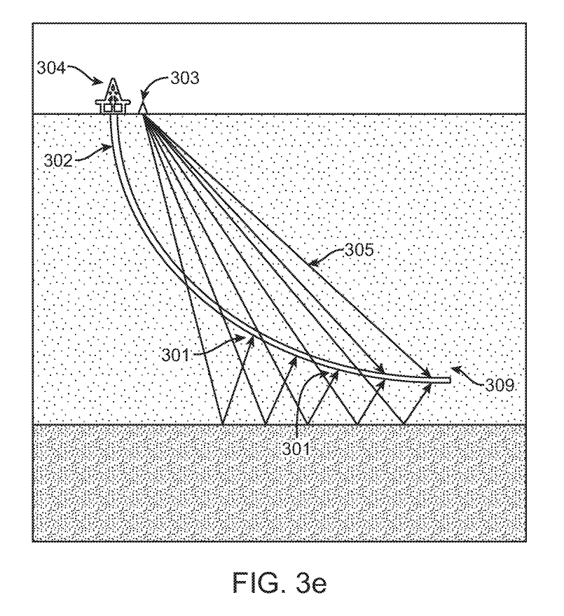

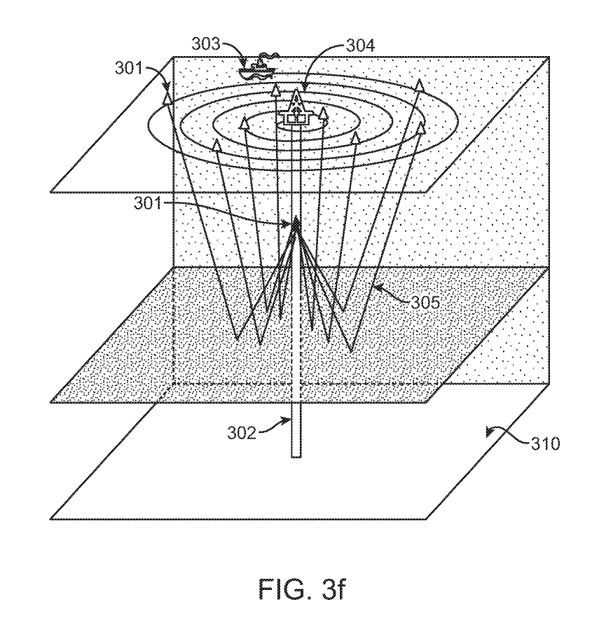

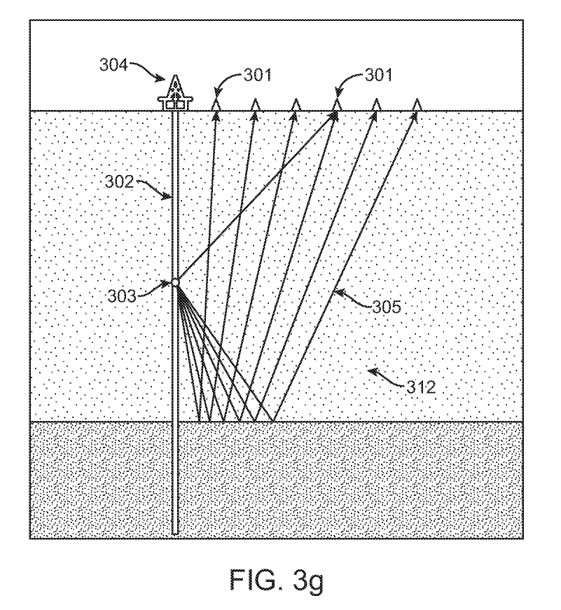

FIG. 3a is a schematic illustration of a system 300 for obtaining a zero-offset VSP. As shown, an array of sensors 301 is positioned within a well bore 302 at a known position. A vibration source 303 is positioned as close as possible to a well head 304. The vibration source 303 emits one or more vibrations 305 at one or more times. The array of sensors 301 detect the vibrations 305. Times of arrival of compressional and shear waves can be compared relative to the time at which the vibrations 305 were emitted from the vibration source 303. The array of sensors 301 can be moved to another position within the well bore 302 and the process can be repeated to determine interval velocities along the entire well bore 302.

FIG. 3b is a schematic illustration of a system 306 for obtaining an offset VSP. As shown, an array of sensors 301 is positioned within a well bore 302 at a known position. A vibration source 303 is positioned a distance from the well head 304. The vibration source 303 emits one or more vibrations 305 at one or more times. The array of sensors 301 detect the vibrations 305. Times of arrival of compressional and shear waves can be compared relative to the time at which the vibrations 305 were emitted from the vibration source 303. The array of sensors 301 can be moved to another position within the well bore 302 and the process can be repeated to determine interval velocities along the entire well bore 302.

FIG. 3c is a schematic illustration of a system 307 for obtaining a walkaway VSP. As shown, an array of sensors 301 is positioned within a well bore 302 at a known position. A plurality of vibration sources 303 are positioned at multiple positions around a well head 304. The vibration sources 303 emit a plurality of vibrations 305 at one or more times. The array of sensors 301 detect the vibrations 305. Times of arrival of compressional and shear waves can be compared relative to the time at which the vibrations 305 were emitted from the vibration source 303. The array of sensors 301 can be moved to another position within the well bore 302 and the process can be repeated to determine interval velocities along the entire well bore 302. The resulting walkaway VSP includes multiple source positions for each receiver position.

FIG. 3d is a schematic illustration of a system 308 for obtaining an offset VSP. As shown, an array of sensors 301 is positioned within a well bore 302 at one or more known positions. One or more vibration sources 303 are positioned at varying distances from the well head 304. Each of the vibration sources 303 is positioned vertically above one of the array of sensors 301. The vibration sources 303 emit one or more vibrations 305 at one or more times. The array of sensors 301 detect the vibrations 305. Times of arrival of compressional and shear waves can be compared relative to the time at which the vibrations 305 were emitted from the vibration source 303. The array of sensors 301 can be moved to another position within the well bore 302 and the process can be repeated to determine interval velocities along the entire well bore 302.

FIG. 3e is a schematic illustration of a system 309 for obtaining a zero offset VSP for a deviated well. As shown, an array of sensors 301 is positioned within a well bore 302 at one or more known positions. One or more vibration sources 303 are positioned at varying distances from the well head 304. The vibration source 303 emits one or more vibrations 305 at one or more times. The array of sensors 301 detect the vibrations 305. Times of arrival of compressional and shear waves can be compared relative to the time at which the vibrations 305 were emitted from the vibration source 303. The array of sensors 301 can be moved to another position within the well bore 302 and the process can be repeated to determine interval velocities along the entire well bore 302.

FIG. 3f is a schematic illustration of a system 310 for obtaining a 3D VSP. As shown, an array of sensors 301 is positioned within a well bore 302 at a known position. A moving station 311, such as a ship, translates one or more vibration sources 303 to multiple positions around a well head 304, for example in a spiral pattern. The vibration sources 303 emit a plurality of vibrations 305 at one or more times. The array of sensors 301 detect the vibrations 305. Times of arrival of compressional and shear waves can be compared relative to the time at which the vibrations 305 were emitted from the vibration source 303. The array of sensors 301 can be moved to another position within the well bore 302 and the process can be repeated to determine interval velocities along the entire well bore 302.

FIG. 3g is a schematic illustration of a system 312 for obtaining a reverse VSP. As shown, an array of sensors 301 is positioned on the surface adjacent to a well head 304 at known positions. One or more vibration sources 303 are positioned at multiple positions in the well bore 302. The vibrations sources can include any source, including but not limited to a perforation shot or a drill bit. The vibration sources 303 can emit a plurality of vibrations 305 at one or more times. The array of sensors 301 detect the vibrations 305. Times of arrival of compressional and shear waves can be compared relative to the time at which the vibrations 305 were emitted from the vibration source 303. If desired, the array of sensors 301 can be moved to another position and the process can be repeated to determine interval velocities along the entire well bore 302. Alternatively, the one or more vibration sources 303 can be moved to a another position within the well bore 302 and the process can be repeated.

Zero-offset VSP is one exemplary embodiment and can help to produce a very reliable anisotropic velocity model. This is because, Zero-offset VSP can accurately determine two of the five unknown stiffness coefficients from Equation 3. Therefore, only three coefficients need to be inverted using perforation data. The decreasing number of unknowns makes velocity calibration results more reliable and more unique.

For a straight or slightly deviated well, a zero-offset VSP can be used where the surface seismic sources are positioned near the wellhead and a series of geophones are clamped along the borehole. If the wellbore is deviated (more than about 10 degrees), a normal-incident VSP survey can be conducted by moving the source over the geophone to remain normal incident. Again the geophones are clamped along the borehole.

In a VTI medium, the P- and S-wave velocities along vertical symmetry axis are given by Equation 4:

$$\{ \begin{matrix}{V}_{p 0} = \sqrt{\frac{{c}_{33}}{ρ}} \\ {V}_{s 0} = \sqrt{\frac{{c}_{55}}{ρ}}\end{matrix} , \qquad ( 4 )$$

where ρ is the density and c₃₃ and c₅₅ are stiffness coefficients of the material.

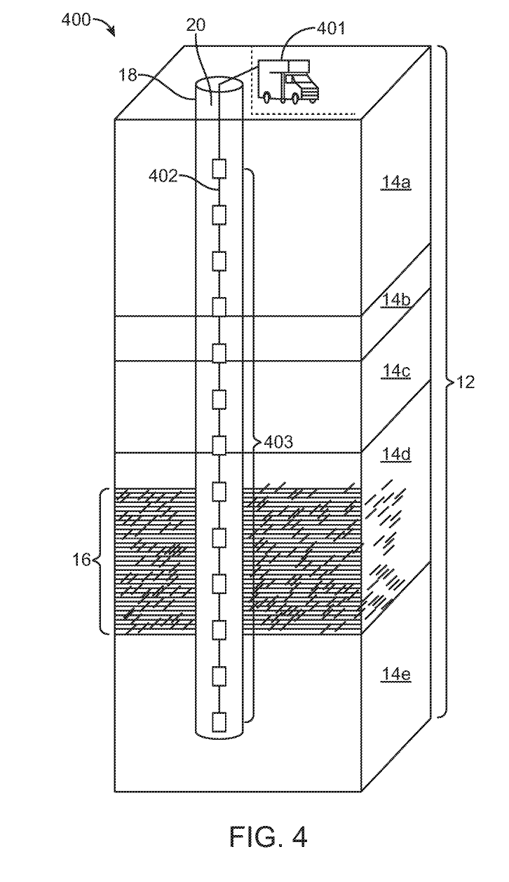

FIG. 4 is a schematic diagram of a partial cutaway view 400. The view is shown with the treatment well 18 comprising a bore 20, shown in FIG. 1 that extends downward into strata 12, through one or more geological layers 14 a-14 e. As shown in FIG. 4, a wireline 402 comprising an array of receiver units 403 coupled to wireline 402 can be positioned within the bore 20. The receiver units 403 preferably contain tri-axial seismic receivers (transducers) such as geophones or accelerometers, i.e., three orthogonal geophones or accelerometers, although for some applications it will not be necessary that receivers be used for all three directions. The type of receiver unit chosen will depend upon the characteristics of the event to be detected. In one embodiment, the characteristic may be the frequency of the event. One or more vibration sources 401 can be positioned at the surface. Any of the methods for obtaining a VSP described herein, including in FIGS. 3a-3g, can be employed to obtain a VSP survey of the well 18 and the strata 12.

The field operations for a zero-offset VSP add some additional time to a microseismic monitoring project. As already discussed, an array of sensors must be clamped or otherwise positioned in the well at known positions. Additionally, surface vibration sources, such as source shots, vibrators, or explosives need to be positioned and triggered to yield times of arrival of compressional and shear waves relative to the shot time. Once sufficiently good quality data are obtained, the array can be moved to a new position, more shots can be taken, and this process can be repeated until the entire well is interrogated from the near-surface to the depth of microseismic investigation. Using the timing of the arrivals and the known positions of arrays of sensors, interval velocities can be determined along the entire well, particularly, Vₚ₀ and Vs₀. These extra VSP set-ups and operations can take time to execute, however, the rest of the stiffness coefficients can be determined with greater accuracy using the obtained vertical velocities.

In both zero-offset and normal incident VSP surveys, seismic velocities are measured in the borehole by recording the travel time required for a seismic pulse generated by a surface energy source to reach a geophone anchored at various levels in the borehole. For a VTI medium, these measured velocities are Vₚ₀ and Vₛ₀ as the seismic rays are traveling along the almost vertical line from the source to the geophone. According to various embodiments, the stiffness coefficients c₃₃ and c₅₅ can be determined by these VSP measurements by using Equation 4. The three remaining unknown stiffness coefficients (c11, c66 and c13) in Equation 3 can be solved using microseismic calibaration data, i.e. data as exemplified in FIG. 2.

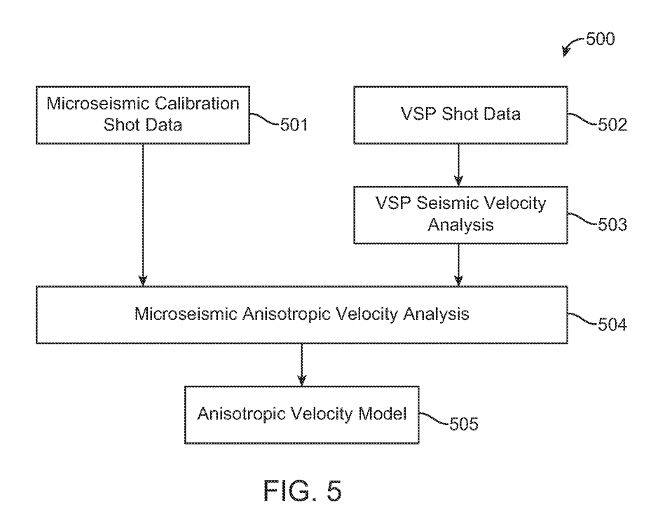

FIG. 5 is a schematic block diagram of an exemplary workflow 500 of microseismic anisotropic velocity analysis according to various embodiments. At box 501, microseismic calibration shot data is acquired. At box 502, VSP shot data is acquired. A VSP Seismic Velocity analysis is conducted at box 503 yielding Vp0 and Vs0. These calculated velocities and the microseismic calibration data are used by the microseismic anisotropic velocity analysis at box 504 along with the microseismic calibration shot data from box 501 to produce a reliable anisotropic velocity model at box 505.

In order to carry out any steps or calculations according to the present disclosure, computing or processing devices having processors can be employed for example in the transmitter system 30 or analysis system 32, or elsewhere, together or separately via personal computers, networks, or employing one or more processors. Devices implementing methods according to these disclosures can comprise hardware, firmware and/or software, or other code and can take any of a variety of form factors. Furthermore, the present technology can employ storage memory or device for storing program code for use by or in connection with one or more computers, processors, or instruction execution system.

For the purposes of this description, the storage memory or device can be any apparatus that can contain, store, communicate, propagate, or transport a program for use by or in connection with the instruction execution system, apparatus, or device. The medium can be an electronic, magnetic, optical, electromagnetic, infrared, or semiconductor system (or apparatus or device) or a propagation medium (though propagation mediums in and of themselves as signal carriers are not included in the definition of physical computer-readable medium). Examples of a physical computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD. Both processors and program code for implementing each as aspect of the technology can be centralized or distributed (or a combination thereof) as known to those skilled in the art.

A data processing system suitable for storing and executing program code can include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters can also be coupled to the system to enable the data processing system to become coupled to other data processing systems or remote printers or storage devices through intervening private or public networks. Modems, cable modem and Ethernet cards are just a few of the currently available types of network adapters. Such systems can be centralized or distributed, e.g., in peer-to-peer and client/server configurations.

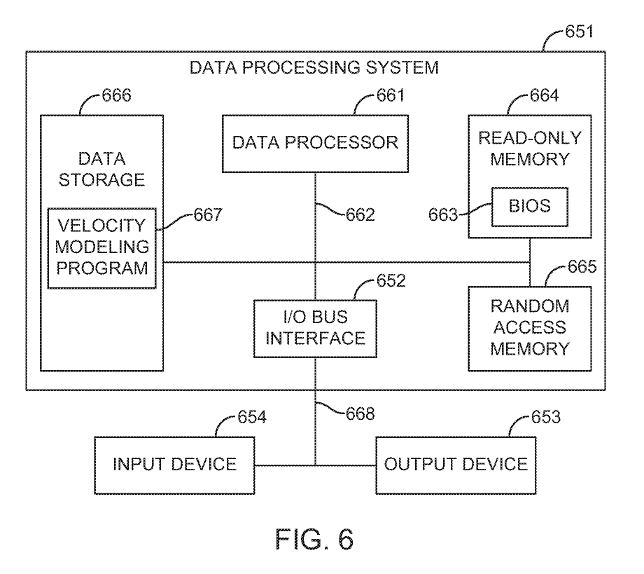

FIG. 6 is a block diagram of a hardware computer 651 having an interface 652 for an anisotropic velocity modeling device 653 and receivers 654. The computer 651 has a data processor 661, which may contain multiple core CPUs and cache memory shared among the core CPUs. The data processor 661 has a system bus 662. The system bus 662 can be any of several types of bus structures including a memory bus or memory controller, a peripheral bus, and a local bus using any of a variety of bus architectures. Basic input/output routines (BIOS) 663 stored in read-only memory 664 provide basic routines that help to transfer information between elements within the computer 651, such as during start-up. The computer 651 also has random access memory 665, and computer-readable storage media such as flash memory 666 coupled to the system bus 662. The flash memory 666 stores a velocity modeling program 667 and a log 668.

Numerous examples are provided herein to enhance understanding of the present disclosure. A specific set of examples are provided as follows. In a first example, a method for producing an anisotropic velocity model is disclosed, the method including obtaining vertical seismic profile (VSP) data for a geological area; calculating, via a processor, p-wave and s-wave velocities along a vertically symmetrical axis using the VSP data; calculating, via a processor, at least two stiffness coefficients in a fourth-rank elasticity stiffness tensor using the p-wave and s-wave velocities; obtaining microseismic profile data for the geological area; calculating, via a processor, all remaining unknown stiffness coefficients in the fourth-rank elasticity stiffness tensor using the microseismic profile data.

In a second example, a method is disclosed according to the first example, wherein three unknown stiffness coefficients are calculated using the microseismic profile data.

In a third example, a method is disclosed according to the first example or the second example, wherein the microseismic profile data is obtained during perforation of a well bore.

In a fourth example, a method is disclosed according to the first, second, or third example, wherein the microseismic profile data is collected by an array of receivers positioned in an adjacent well bore during the perforation.

In a fifth example, a method is disclosed according to the fourth example, wherein the VSP data is collected by a second array of receivers positioned in the adjacent well bore.

In a sixth example, a method is disclosed according to the any of the first through fifth examples, wherein the VSP data is obtained via one selected from the group consisting of a zero-offset VSP acquisition method, an offset VSP acquisition method, a walkaway VSP acquisition method, a normal incidence VSP acquisition method, a three-dimensional VSP acquisition method, a reverse VSP acquisition method, and combinations thereof.

In a seventh example, a method is disclosed according to any of the first through sixth examples, wherein the fourth-rank elasticity stiffness tensor (C^{VTI}) is approximated in 2-index Voigt notation as:

$${C}^{VTI} = ( \begin{matrix}{c}_{11} & {c}_{11} - 2 {c}_{66} & {c}_{13} & 0 & 0 & 0 \\ {c}_{11} - 2 {c}_{66} & {c}_{11} & {c}_{13} & 0 & 0 & 0 \\ {c}_{13} & {c}_{13} & {c}_{33} & 0 & 0 & 0 \\ 0 & 0 & 0 & {c}_{55} & 0 & 0 \\ 0 & 0 & 0 & 0 & {c}_{55} & 0 \\ 0 & 0 & 0 & 0 & 0 & {c}_{66}\end{matrix} ) .$$

In an eighth example, a method is disclosed according to the seventh example, wherein the p-wave velocity (Vₚ₀) and the s-wave velocity (Vₛ₀) are given by:

$$\{ \begin{matrix}{V}_{p 0} = \sqrt{\frac{{c}_{33}}{ρ}} \\ {V}_{s 0} = \sqrt{\frac{{c}_{55}}{ρ}}\end{matrix} ,$$

In a ninth example, a method is disclosed according to the seventh example, wherein the at least two stiffness coefficients determined by the p-wave and s-wave velocities comprise c₃₃ and c₅₅.

In a tenth example, a method is disclosed according to any of the first through ninth examples, wherein the microseismic profile data is obtained during perforation of a well casing in the geological area.

In an eleventh example, a method is disclosed according to the tenth example, wherein the microseismic profile data is collected by one or more receiver units in a second well adjacent to the well casing.

In an twelfth example, a method is disclosed according to the eleventh example, wherein the VSP data is collected by one or more VSP receivers positioned in the second well adjacent to the well casing.

In a thirteenth example, a system for producing an anisotropic velocity model, the system including a processor; and a computer readable medium having stored thereon a plurality of instructions for causing the processor to perform a method including: calculating, via a processor, p-wave and s-wave velocities along a vertically symmetrical axis using vertical seismic profile (VSP) data for a geological area; calculating, via a processor, at least two stiffness coefficients in a fourth-rank elasticity stiffness tensor using the p-wave and s-wave velocities; calculating, via a processor, all remaining unknown stiffness coefficients in the fourth-rank elasticity stiffness tensor using microseismic profile data for the geological area.

In a fourteenth example, a method is disclosed according to the thirteenth example, wherein three unknown stiffness coefficients are calculated using the microseismic profile data.

In a fifteenth example, a method is disclosed according to any of the thirteenth through fourteenth examples, wherein the microseismic profile data is obtained during perforation of a well bore.

In a sixteenth example, a method is disclosed according to the fifteenth example, wherein the microseismic profile data is collected by an array of receivers positioned in an adjacent well bore during the perforation.

In a seventeenth example, a method is disclosed according to any of the thirteenth through sixteenth examples, wherein the VSP data is obtained via one selected from the group consisting of a zero-offset VSP acquisition method, an offset VSP acquisition method, a walkaway VSP acquisition method, a vertical incidence VSP acquisition method, a three-dimensional VSP acquisition method, a reverse VSP acquisition method, and combinations thereof.

In an eighteenth example, a method is disclosed according to any of the thirteenth through seventeenth examples, wherein the fourth-rank elasticity stiffness tensor (CVTI) is approximated in 2-index Voigt notation as:

$${C}^{VTI} = ( \begin{matrix}{c}_{11} & {c}_{11} - 2 {c}_{66} & {c}_{13} & 0 & 0 & 0 \\ {c}_{11} - 2 {c}_{66} & {c}_{11} & {c}_{13} & 0 & 0 & 0 \\ {c}_{13} & {c}_{13} & {c}_{33} & 0 & 0 & 0 \\ 0 & 0 & 0 & {c}_{55} & 0 & 0 \\ 0 & 0 & 0 & 0 & {c}_{55} & 0 \\ 0 & 0 & 0 & 0 & 0 & {c}_{66}\end{matrix} ) .$$

In a nineteenth example, a method is disclosed according to the eighteenth example, wherein the p-wave velocity (Vp0) and the s-wave velocity (Vs0) are given by:

$$\{ \begin{matrix}{V}_{p 0} = \sqrt{\frac{{c}_{33}}{ρ}} \\ {V}_{s 0} = \sqrt{\frac{{c}_{55}}{ρ}}\end{matrix} ,$$

where ρ is the density of a material in the geological area.

In a twentieth example, a method is disclosed according to any of the eighteenth through nineteenth examples, wherein the at least two stiffness coefficients determined by the p-wave and s-wave velocities comprise c33 and c55.

In a twenty-first example, a method is disclosed according to any of the eighteenth through twentieth examples, wherein the microseismic profile data is obtained during perforation of a well casing in the geological area.

In a twenty-second example, a method is disclosed according to the twenty-first example, wherein the microseismic profile data is collected by one or more receiver units in a second well adjacent to the well casing.

In an twenty-third example, a method is disclosed according to the twenty second example, wherein the VSP data is collected by one or more VSP receivers positioned in the second well adjacent to the well casing.

The embodiments shown and described above are only examples. Many details are often found in the art such as the other features of a logging system. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure to the full extent indicated by the broad general meaning of the terms used in the attached claims. It will therefore be appreciated that the embodiments described above may be modified within the scope of the appended claims.

1. A method for producing an anisotropic velocity model, the method comprising:
obtaining vertical seismic profile (VSP) data for a geological area;
calculating, via a processor, p-wave and s-wave velocities along a vertically symmetrical axis using the VSP data;
calculating, via a processor, at least two stiffness coefficients in a fourth-rank elasticity stiffness tensor using the p-wave and s-wave velocities;
obtaining microseismic profile data for the geological area;
calculating, via a processor, all remaining unknown stiffness coefficients in the fourth-rank elasticity stiffness tensor using the microseismic profile data.

2. The method according to claim 1, wherein three unknown stiffness coefficients are calculated using the microseismic profile data.

3. The method according to claim 1, wherein the microseismic profile data is obtained during perforation of a well bore.

4. The method according to claim 3, wherein the microseismic profile data is collected by an array of receivers positioned in an adjacent well bore during the perforation.

5. The method according to claim 4, wherein the VSP data is collected by a second array of receivers positioned in the adjacent well bore.

6. The method according to claim 1, wherein the VSP data is obtained via one selected from the group consisting of a zero-offset VSP acquisition method, an offset VSP acquisition method, a walkaway VSP acquisition method, a normal incidence VSP acquisition method, a three-dimensional VSP acquisition method, a reverse VSP acquisition method, and combinations thereof.

7. The method according to claim 1, wherein the fourth-rank elasticity stiffness tensor (C^{VTI}) is approximated in 2-index Voigt notation as:
$${C}^{VTI} = ( \begin{matrix}{c}_{11} & {c}_{11} - 2 {c}_{66} & {c}_{13} & 0 & 0 & 0 \\ {c}_{11} - 2 {c}_{66} & {c}_{11} & {c}_{13} & 0 & 0 & 0 \\ {c}_{13} & {c}_{13} & {c}_{33} & 0 & 0 & 0 \\ 0 & 0 & 0 & {c}_{55} & 0 & 0 \\ 0 & 0 & 0 & 0 & {c}_{55} & 0 \\ 0 & 0 & 0 & 0 & 0 & {c}_{66}\end{matrix} ) .$$

8. The method according to claim 7, wherein the p-wave velocity (Vₚ₀) and the s-wave velocity (Vₛ₀) are given by:
$$\{ \begin{matrix}{V}_{p 0} = \sqrt{\frac{{c}_{33}}{ρ}} \\ {V}_{s 0} = \sqrt{\frac{{c}_{55}}{ρ}}\end{matrix} ,$$
where ρ is the density of a material in the geological area.

9. The method according to claim 7, wherein the at least two stiffness coefficients determined by the p-wave and s-wave velocities comprise c₃₃ and c₅₅.

10. The method according to claim 1, wherein the microseismic profile data is obtained during perforation of a well casing in the geological area.

11. The method according to claim 10, wherein the microseismic profile data is collected by one or more receiver units in a second well adjacent to the well casing.

12. The method according to claim 11, wherein the VSP data is collected by one or more VSP receivers positioned in the second well adjacent to the well casing.

13. A system for producing an anisotropic velocity model, the system comprising a processor; and a computer readable medium having stored thereon a plurality of instructions for causing the processor to perform a method comprising:
calculating, via a processor, p-wave and s-wave velocities along a vertically symmetrical axis using vertical seismic profile (VSP) data for a geological area;
calculating, via a processor, at least two stiffness coefficients in a fourth-rank elasticity stiffness tensor using the p-wave and s-wave velocities;
calculating, via a processor, all remaining unknown stiffness coefficients in the fourth-rank elasticity stiffness tensor using microseismic profile data for the geological area.

14. The system according to claim 13, wherein three unknown stiffness coefficients are calculated using the microseismic profile data.

15. The system according to claim 13, wherein the microseismic profile data is obtained during perforation of a well bore.

16. The system according to claim 15, wherein the microseismic profile data is collected by an array of receivers positioned in an adjacent well bore during the perforation.

17. The system according to claim 13, wherein the VSP data is obtained via one selected from the group consisting of a zero-offset VSP acquisition method, an offset VSP acquisition method, a walkaway VSP acquisition method, a vertical incidence VSP acquisition method, a three-dimensional VSP acquisition method, a reverse VSP acquisition method, and combinations thereof.

18. The system according to claim 13, wherein the fourth-rank elasticity stiffness tensor (CVTI) is approximated in 2-index Voigt notation as:
$${C}^{VTI} = ( \begin{matrix}{c}_{11} & {c}_{11} - 2 {c}_{66} & {c}_{13} & 0 & 0 & 0 \\ {c}_{11} - 2 {c}_{66} & {c}_{11} & {c}_{13} & 0 & 0 & 0 \\ {c}_{13} & {c}_{13} & {c}_{33} & 0 & 0 & 0 \\ 0 & 0 & 0 & {c}_{55} & 0 & 0 \\ 0 & 0 & 0 & 0 & {c}_{55} & 0 \\ 0 & 0 & 0 & 0 & 0 & {c}_{66}\end{matrix} ) .$$

19. The system according to claim 18, wherein the p-wave velocity (Vp0) and the s-wave velocity (Vs0) are given by:
$$\{ \begin{matrix}{V}_{p 0} = \sqrt{\frac{{c}_{33}}{ρ}} \\ {V}_{s 0} = \sqrt{\frac{{c}_{55}}{ρ}}\end{matrix} ,$$
where ρ is the density of a material in the geological area.

20. The system according to claim 18, wherein the at least two stiffness coefficients determined by the p-wave and s-wave velocities comprise c33 and c55.

21. The system according to claim 18, wherein the microseismic profile data is obtained during perforation of a well casing in the geological area.

22. The system according to claim 21, wherein the microseismic profile data is collected by one or more receiver units in a second well adjacent to the well casing.

23. The system according to claim 22, wherein the VSP data is collected by one or more VSP receivers positioned in the second well adjacent to the well casing.
